(19) United States
(12) Patent Application Publication
(10) Pub. No.: US 2009/0141435 A1
(43) Pub. Date: Jun. 4, 2009

(54) CONTAINERS FOR TRANSPORTING DATA FROM A FIRST PHYSICAL LOCATION TO A SECOND PHYSICAL LOCATION

(76) Inventors: Barrett Kreiner, Wookstock, GA (US); Jonathan Reeves, Roswell, GA (US)

Correspondence Address: AT&T Legal Department - WK;Attn: Patent Docketing, Room 2A-207, One AT&T Way, Bedminster, NJ, 07921, US

(21) Appl. No.: 11/947,096

(22) Filed: Nov. 29, 2007

(51) Int. Cl. G06F 1/18; G06F 13/00; G06F 1/16

(52) U.S. Cl. 361/679.4; 710/33

(57) ABSTRACT

Containers provide for the retrieval of data from a data source at a first location and for transport to a second location where the data may be uploaded to a backup system. The containers may include multiple components such as a transfer housing that has a physical connection to a data source and a storage housing that may have a contactless data connection to the transfer housing. The storage housing may be hermetically sealed such that decontamination of the storage housing may be achieved. Accordingly, the storage housing may rescue data from a data source at a contaminated location, be moved to a decontamination zone where decontamination of the storage housing occurs, and then be moved to an uncontaminated location for upload via a transfer housing to the backup system.

### TECHNICAL FIELD

Embodiments relate to transporting data. More particularly, embodiments relate to a container that physically transports data from a first location to a second location.

### BACKGROUND

Data often needs to be transported from a first physical location to a second physical location. While electronic forms of transfer are often the most convenient way to achieve the transport, electronic forms of transfer are not always available or practical. For example, a first location where data is located may be isolated from electronic forms of transport due to a lack of network connectivity, lack of utility power, or other similar problem.

Portable storage devices allow for data to be physically transferred from a first location to a second location. Portable hard disk drives, flash memory, and the like have made physical transport of data easier to achieve where electronic forms of transfer are not available or practical. However, under certain circumstances, even conventional portable storage devices may not be feasible for transporting the data.

One such example occurs when the first location where the data is located has become contaminated with volatile gases, liquids, radiation, and/or other contaminants. In such a case, the storage devices themselves, whether fixed or portable, may be contaminated. These devices cannot be decontaminated and remain functional in most instances due to their susceptibility to damage and, therefore, are trapped at the contamination site. As these devices continue to be exposed to the contaminants, their integrity from both a data and a structural perspective become compromised, and the data may be lost.

### SUMMARY

Embodiments address issues such as these and others by providing a container that has a hermetically sealed storage housing that contains a data storage device. The storage housing may also include additional characteristics such as radiation shielding and non-porous exterior surfaces. A transfer housing interfaces to a data source and communicates in a contactless manner with the storage housing to transfer data from the data source to the storage device within the storage housing. The storage housing may then may physically moved to another location where the same or another transfer housing may be used to transfer data from the storage device to a data backup location. For instances where the location of the data source was contaminated, the storage housing may be decontaminated without damaging the storage device containing the transferred data since the storage housing is hermetically sealed and has contactless communication features.

Embodiments may provide a container that transfers data from one physical location to another. The container includes a mobile hermetically sealed storage housing, a data storage device within the storage housing, and a contactless data coupler that is within the storage housing. The contactless data coupler is in electrical communication with the data storage device, receives contactless data signals that originate outside of the storage housing, saves data from the received contactless data signals to the data storage device, extracts data from the data storage device, and sends the extracted data via contactless data signals that reach outside of the storage housing.

Embodiments may provide a container that transfers data from one physical location to another that includes a mobile hermetically sealed transfer housing, a physical data connector exposed to the exterior of the transfer housing, and a contactless data coupler that is within the transfer housing. The contactless data coupler is in electrical communication with the physical data connector, receives data signals from the physical data connector, and sends the received data signals via contactless data signals that reach outside of the transfer housing.

Embodiments may also provide a computer readable medium containing instructions thereon that perform acts that include recognizing via a contactless data coupling located within a hermetically sealed storage housing that a data device exterior to the storage housing is available. The acts further include sending commands outside of the storage housing via the contactless data coupling to initiate data retrieval from the data device. The acts include receiving within the storage housing data signals that originate outside of the storage housing via the contactless data coupling where the data signals are representative of data retrieved from the data device and loading data from the data signals into a storage device located within the storage housing.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE DRAWINGS

FIG. 1 shows an environment that includes a container according to various embodiments that moves between a hot zone, decontamination zone, and a cold zone to transfer data.

FIG. 2 shows an example of a transfer housing of a container according to various embodiments.

FIG. 3 shows an example of a storage housing of a container according to various embodiments.

FIG. 4 shows an example of a set of logical operations being performed by a container according to various embodiments.

### DETAILED DESCRIPTION

Embodiments provide for the physical movement of data from a first location to a second location by having a container that utilizes contactless communication to receive data at the first location and to provide the data for backup at the second location. The container may have a storage housing that can be decontaminated such that the storage housing may enter a contaminated area to receive the data, leave the contaminated area and be decontaminated, and then enter a clean area where the data may be output from the storage housing.

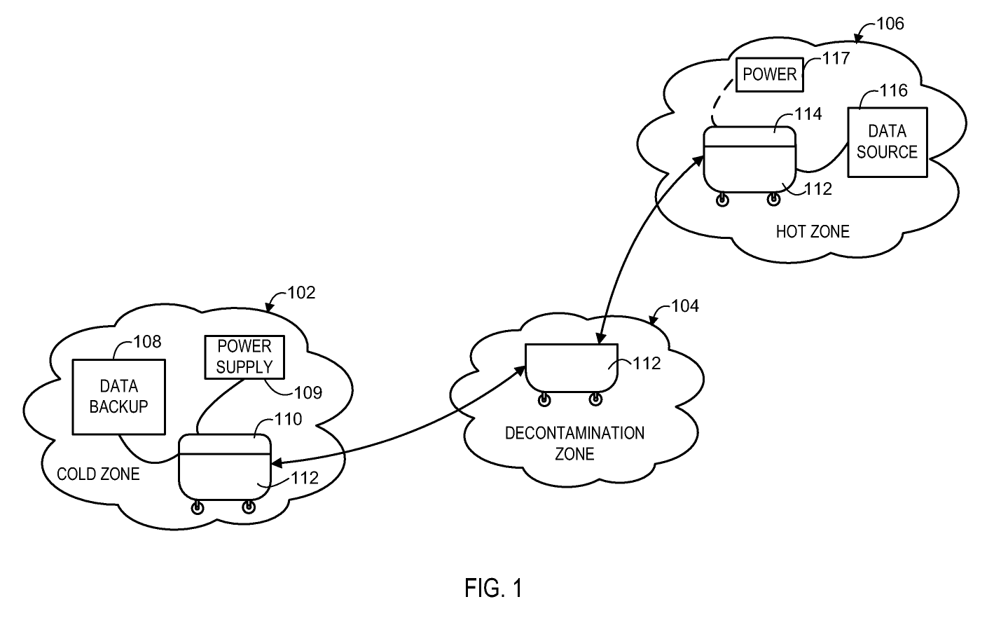

FIG. 1 shows one example of an operating environment for the container. In this example, the container includes a transfer housing 110, 114 and a storage housing 112. In the situation shown, data to be rescued is located at a data source 116 within a hot zone 106. The hot zone 106 is contaminated such that the data source 116 will eventually be destroyed and the data within the data source 116 will eventually be lost. The data source 116 may be a peripheral device such as an internal or external hard disk, floppy disk, flash memory, and the like that contains data to be rescued. Alternatively, the data source 116 may be a functional computer system having one or more storage devices containing data to be rescued.

To rescue the data within the data source 116, the container including the storage housing 112 and the transfer housing 114 is moved into the hot zone 106. The transfer housing 114 establishes a physical connection to the data source 116. This physical connection may allow the transfer housing 114 to act as a host for the data source 116, such as where the data source 116 is a storage device that has been removed from a host computer that is no longer operable. The physical connection may alternatively allow the transfer housing 114 to act as a peripheral for the data source 116, such as where the data source 116 is a local computer system that is still operational and that has one or more logically accessible storage devices.

Where the transfer housing 114 is acting as a host for the data source 116, the transfer housing 114 may have a bay for insertion of an internal hard disk drive, a port for connecting to an external disk drive, disk drives for receiving floppy disks or zip disks, ports for receiving flash memory devices, and/or other data connections for communicating with a storage device. Where the transfer housing 114 is acting as a peripheral, the transfer housing 114 may emulate an internal or external disk drive, flash memory, and the like via a plug or data card connection to an internal or external port of the data source 116.

According to exemplary embodiments, the transfer housing 114 communicates with the storage housing 112 through a contactless data coupling in order to load the data being read from the data source 116 into a storage device within the storage housing 112. The storage housing 112 may then be removed from the hot zone 106 once the data has been loaded. In order to preserve the functionality of the transfer housing 114 while it is present within the hot zone 106, it may be hermetically sealed although the physical connectivity to the data source 116 may be exposed. As the transfer housing 114 is separable from the storage housing 112, the transfer housing 114 may be left within the hot zone 106. According to some embodiments, the transfer housing 114 may be removed and decontaminated and then refurbished to the extent necessary to restore operability otherwise lost due to the contamination.

While in the hot zone 106, the transfer housing 114 may also have external power ports for physically connecting to a power source 117. The power source 117 may be the public utility AC power that may still be functional or may be battery back-up power that is present and functional. As discussed below, the transfer housing 114 may utilize the power from this power source 117 while also providing power to the storage housing 112 through the contactless connectivity.

In accordance with exemplary embodiments, the storage housing 112 is hermetically sealed and no data connections are exposed as the data connectivity is established through contactless data coupling with the transfer housing 114. Therefore, the storage housing 112 is not affected by the contaminants and may be thoroughly decontaminated. Thus, upon receiving all of the data to be copied from the data source 116, the storage housing 112 is moved to a decontamination zone 104 where the storage housing 112 is decontaminated.

Decontamination of an exterior of hermetically sealed containers is well known to those of ordinary skill in the art. Decontamination often involves significant amounts of water and soaps which are harmful to exposed electronics. In some cases, stronger chemicals such as chlorine may be used and these may be even more harmful to exposed electronics and precise metal connectors and contacts. Thus, hermetically sealing the container at least reduces if not eliminates the likelihood of damaging sensitive electronics and data storage devices. The hermetically sealed container may also be decontaminated using techniques not suitable for the decontamination of humans, such as ultraviolet sterilization, Triclosan, alcohol, or other strong chemicals.

After decontamination, the storage housing 112 may be safely moved to a cold zone 102 which is substantially free of the contaminants present in the hot zone 106. According to exemplary embodiments, the cold zone 102 has a data back-up system 108, such as a storage device or computer system that can substitute for the data source 116 of the hot zone 106. A transfer housing, such as the transferring housing 110, is also present within the cold zone 102 to provide a contactless data coupling with the storage housing 112. The transfer housing 110 maintains a physical data connection with the data backup system 108. The physical connection may be any of the examples discussed above in relation to the physical connectivity of the transfer housing 114.

Thus, the connectivity in the cold zone 102 may be the same as or similar to the connectivity that occurred in the hot zone 106. However, in the cold zone 102, the storage housing 112 sends data to the transfer housing 110 through the contactless data coupling, and the transfer housing 110 then loads the data to the data backup 108 through the physical connection. In this manner, data from the hot zone 106 which is on the verge of being lost may be physically transferred to the cold zone 102 where the data can be preserved.

In the cold zone 102, the transfer housing 110 may maintain a physical connection to a power supply 109, such as the public utility AC power or a battery backup and may utilize this power for operations. Furthermore, the transfer housing 110 may provide power to the storage housing 112 to provide for the storage housing's operations in the cold zone 102 through a contactless power coupling. Additionally, the transfer housing 110 may provide power to the storage housing 112 for purposes of charging batteries within the storage housing 112 that maintain power for the storage housing 112 and the transfer housing 114 when in the hot zone 106 if the power source 117 is not present.

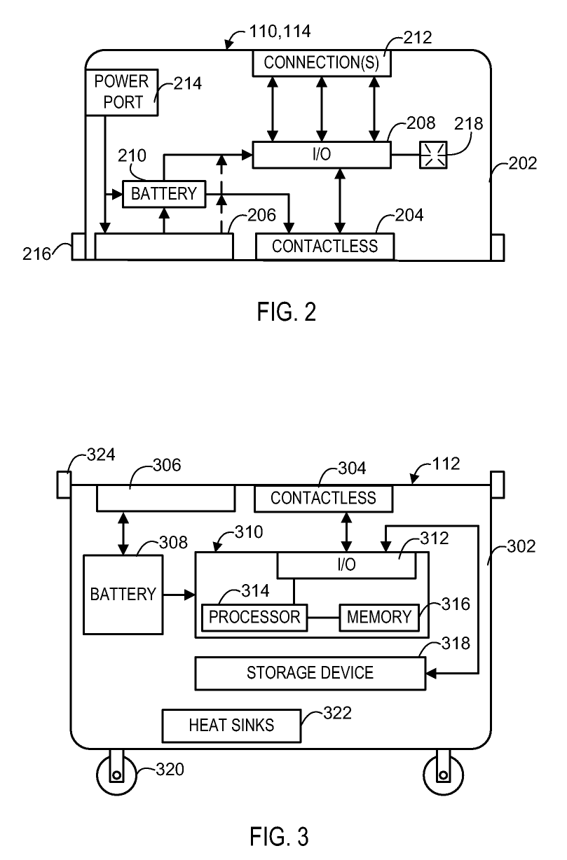

FIG. 2 shows one example of a transfer housing, such as the transfer housing 110, 114. The transfer housing 110, 114 may include a contamination resistant shell 202. The shell 202 may be hermetically sealed to resist the introduction of contaminants into the interior of the transfer housing 110, 114 and to preserve the functionality of the internal components for as long as possible within the hot zone 106. Some examples of materials that the shell 202 may be constructed of in order to be resistant to many contaminants include polycarbonate resin thermoplastics such as Lexan® casings which may include embedded anti-microbial substances, Natural Latex, Butyl, Neoprene, Nitrile, Polyvinyl Chloride (PVC), Polyvinyl Alcohol (PVA) Viton® fluoroelastomer, and Silvershield/4H/Barrier molded products which may also include anti-microbial substances. Furthermore, a durable core material such as stainless steel or other metal including those that may provide a degree of radiation shielding may be present and may be coated with one of these substances. The exterior surface of the shell 202 may be made very smooth and non-porous to facilitate decontamination should there be an attempt to retrieve, decontaminate, and refurbish the transfer housing 114.

Within the shell 202 several components are present to provide the data transfer function between the data source 116 and the storage housing 112. Physical connections 212 that are exposed externally of the shell 202 provide for the direction physical connection to the data source 116. As discussed above, the transfer housing 110, 114 may appear as either a host or a peripheral depending upon the nature of the data source 116. Thus, the connections 212 may include one or more of a drive bay with an Integrated Drive Electronics (IDE), Small Computer System Interface (SCSI), or other internal drive connection, a universal serial bus (USB) port or plug, a secure digital (SD) port or card, a Personal Computer Memory Card (PCMCIA) port or PCMCIA card, an IEEE 1394 port of plug, an Ethernet port or plug, and so forth.

The physical connections 212 communicate over a data bus with an input/output (I/O) system 208. The I/O system 208 manages protocol of each of the potential connections and for either the host mode or the peripheral mode of operation. For example, the I/O system 208 may act as an IDE, SCSI, USB, SD, PCMCIA, IEEE 1394, Ethernet or other controller for host mode and/or as an IDE, SCSI, USB, SD, PCMCIA, IEEE 1394, Ethernet, or other storage device for peripheral mode.

The I/O system 208 communicates with the storage housing 112 through a contactless data coupler 204 in order to transfer data received from the connections 212 to the storage housing 112 and in order to transfer data from the storage housing 112 to an external system. The contactless data coupler 204 establishes data transfer without requiring electrical contact between the transfer housing 110, 114 and the storage housing 112. Therefore, the storage housing 112 has no exposed data connectors that are susceptible to damage by contaminants.

The contactless data coupler 204 may be one of various forms. For example, the contactless data coupler 204 may employ radio frequency electromagnetic transmission and reception. Specific examples that may be employed include IEEE 802.11 known as Wi-Fi and/or the Bluetooth® protocol. Other radio frequency techniques and protocols are also applicable. As another example, infrared transfer may be employed. Another example involves optical transfer. Yet another example involves magnetic inductance. In each of these instances, data coupling is achieved without physical contact of electrical conductors as the contactless connection is established by mere proximity of the contactless data coupler 204 to the storage housing 112.

The I/O system 208 may provide an external signal, such as a sound or light generator 218 to indicate to the user that the retrieval of data from the external data source 116 and/or the upload of data to the external storage device 108 has completed. Thus, upon receiving this indication, the user may remove the transfer housing 110, 114 from the storage housing 112 if necessary to transport the storage housing 112 to a different location. As discussed below, this external signal 218 may provide additional indications as well, such as an indication of capacity of a storage device of the storage housing 112 and/or a warning when the capacity is very low.

The I/O system 208 and the contactless data coupler 204 may receive power from an on-board battery 210, from an external power source accessed via an exposed power port 214, or through a contactless power coupler 206. The contactless power coupler 206 may send and receive power to the storage housing 112. For example, the power port 214 may provide power that is provided to the storage housing through the contactless power coupler 206. As another example, the contactless power coupler 206 may receive power being sent from the storage housing 112 to provide power to the I/O system 208 and contactless data coupler 204 and/or to recharge the battery 210 if present. The contactless power coupler 206 may be one of various forms as well, such as a radio frequency heated power converter or a magnetic inductance power converter.

The transfer housing 110, 114 may be temporarily mounted to the storage housing 112. Thus, latches 216 or other attachment mechanisms may be included to mate to counterpart mechanisms of the storage housing 112. Where the contactless data and power couplers 204, 206 are sensitive to positioning relative to the storage housing 112, then these latches 216 may be configured to ensure proper alignment between the transfer housing 110, 114, and the storage housing 112.

FIG. 3 shows an example of a storage housing 112. The storage housing 112 may include a contamination resistant shell 302. The shell 302 is hermetically sealed to prevent the introduction of contaminants into the interior of the storage housing 112. As the shell 302 has no external connections, decontamination of the shell 302 is possible so that the storage housing 112 may be transferred between hot zones 106 and cold zones 102 as needed. Examples of materials that may be used to construct the shell 302 in order to provide resistance to many contaminants include those mentioned above for construction of the shell 202 of the transfer housing 111, 114, such as PVC, PVA, and the like. Furthermore, a durable core with a protective outer coating may be provided for the shell 202 as is discussed above in relation to the shell 302 and/or the exterior surface may be made very smooth and non-porous to facilitate decontamination.

Within the shell 302 several components are present to provide the data exchange with the transfer housing 110, 114. A contactless data coupler 304 is present to communicate with the transfer housing 110, 114, and specifically the contactless data coupler 204. The contactless data coupler 304 may be of any of the forms discussed above for the contactless data coupler 204. The contactless data coupler 304 exchanges the received data with an I/O system 312 which takes the data and stores it to an on-board storage device 318 also located within the shell 302.

The I/O system 312 acts as a device controller for the storage device 318, where the storage device 318 may be of various forms including hard disks, optical disks, flash memory, and the like. Thus, the I/O system 312 may implement any of the control protocols discussed above for the I/O system 208 as is necessary to read and write to the storage device 318. For example, the I/O system 208 may provide an IDE, SCSI, USB, PCMCIA, IEEE 1394, SD, or other control interface to the storage device 318.

As the storage device 318 may be a collection of any number of individual storage devices, the total data capacity may be much larger than any one individual storage device of the hot zone 106. This large capacity may allow a many data sources 117 to be accessed during a single trip into the hot zone 106 to decrease the number of trips necessary. Each data source 117 may be a separate data load into the storage device 318. The storage housing 112 may provide an indicator of available capacity as well as a warning when capacity is very low to prevent overloads. One example of providing such an indicator would be the I/O system 312 communicating with the I/O system 208 of the transfer housing 110, 114 so that the transfer housing may provide the indication via the external indicator 218 upon establishing the contactless connection and continually update the indication during data transfer.

Each load into the storage device 318 may be of a different drive type and configuration of a different load into the same storage device 318. For example, three SCSI devices and one SATA device may be loaded into the same storage device 318. Each load is an image of the device being loaded, the image being represented by a file on the storage device 318. The storage device 318 may then be presented to the data backup 108 as a mass storage device having four different physical medias, three type SCSI and one type SATA drives. The four different physical medias may be retrieved and then re-established at the data backup 108.

The I/O system 312 may operate under control of a processing system 310 that includes a processor 314 and a memory 316. The processor 314 may operate as a conventional computer system to control the I/O system 312 to initiate reading and writing to the storage device 318 and to perform other peripheral control operations. For example, the processor 314 may provide the logic for recognizing the nature of the data source 116 through the interactions between the I/O system 312 and the I/O system 208. Further, the processor 314 may provide control of the I/O system 208 to present the I/O system 208 as a peripheral or as a host to the data source 116.

The processor 314 may be of various forms such as a general purpose programmable processor, an application specific processor, hardwired digital logic, or various combinations thereof. The processor 314 may utilize the memory 316 to store operational data and/or programming being implemented. The processor 314 may provide functions such as redundant array intelligent disk (RAID) control, power management regarding controlling usage of an on-board battery 308 by various components, and so forth.

The processor 314, memory 316, and/or storage device 318 are examples of computer readable media which store instructions that when performed implement various logical operations. Such computer readable media may include various storage media including electronic, magnetic, and optical storage. Computer readable media may also include communications media, such as wired and wireless connections used to transfer the instructions or send and receive other data messages.

The battery 308 may be present within the shell 302 to provide power to the processing system 310, the contactless data coupler 304, and the storage device 318 if no external power is being received through a contactless power coupler 306. Furthermore, the battery 308 may provide power to the transfer housing 110, 114 through the contactless power coupler 306 if the transfer housing 110, 114 lacks an adequate battery, such as the battery 210, or a power connection via the power port 214.

Other features that may be present for the storage housing 112 include internal heat sinks 322 that serve to dissipate heat from the various components into the airspace within the shell 302. Wheels 320 are an example of another feature that may be present to assist in physically moving the storage housing 112, such as where the storage housing 112 contains a physically large collection of storage devices 318 that provide for a very high data capacity. Additionally, latching or other attachment mechanisms 324 may be present to mate to the latching mechanisms 216 of the transfer housing 110, 114 to hold the transfer housing 110, 114 in an appropriate position relative to the storage housing 112.

The storage housing 112 may also be configured for purposes other than primarily data transfer. For example, a storage housing 112 may be configured with a relatively low amount of storage but with a relatively large amount of battery life and with a contactless data coupler, such as the coupler 304, that utilizes radio frequency communication to act as a repeater within the hot zone 106 for extending a range of a wireless network. Furthermore, additional peripheral devices may be located within the shell 302, such as a camera that is directed to the area external of the shell 302 that can capture visual data regarding the state of the hot zone 106.

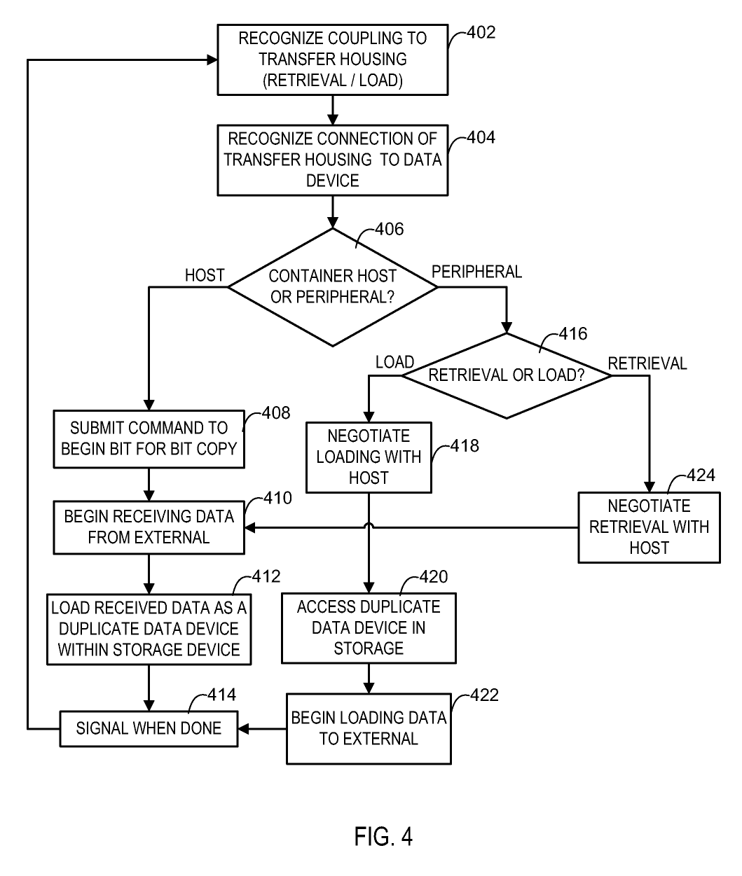

FIG. 4 shows an example of a set of logical operations that may be performed by the processor 314 of the storage housing 112. In this example, the processor 314 interacts with the I/O system 312 and in turn with the I/O system 208 upon the contactless data coupler 204 and contactless data coupler 304 being in adequate proximity. At a coupling operation 402, the processor 314 recognizes that the I/O system 312 has established communication with the I/O system 208.

At this point, the processor 314 then begins to recognize whether the I/O system 208 of the transfer housing 110, 114 has established connectivity to an external data device such as the data source 116 or the data backup 108 at a connection operation 404. The I/O system 208 may report such information upon the physical connection to the external data device occurring. This physical connection may be distinguished and reported once the I/O system 208 detects whether the connection is through a peripheral plug or card of the connections 212 that has been connected to a host port of the data source 116 or data backup 108 or through one of the hosting ports of connections 212 receiving a plug or card of the data source 116 or data backup 108.

The processor 314 detects whether the I/O system 208 is reporting that the transfer housing 110, 114 is connected as a host or peripheral relative to the data source 116 or data backup 108 at determination operation 406. In the example shown, it is presumed that if the transfer housing 110, 114 is connected as a host, then the function is to store a copy of the data from the data source 116 that is the peripheral. However, in this example, if the transfer housing 110, 114 is connected as a peripheral, then the processor 314 detects whether the transfer housing 110, 114 has been connected for purposes of storing a copy of the data from the data source 116 that is the host or for purposes of uploading stored data to the data backup 108 that is the host. This may be determined by awaiting a read or write command from the host, which may be initiated by the user at the host after having physically connected the transfer housing 110, 114 to the host.

It will be appreciated that in other examples, the processor 314 may also attempt to detect whether the transfer housing 110, 114 that is connected as a host has been connected for purposes of copying data from the data source 116 or data backup 108 acting as a peripheral or loading data to the peripheral. For example, this may be determined by reading from the peripheral whether it is identified as a cold zone backup device 108 and if so, then upload from the storage device 318 to the peripheral and otherwise begin copying from the peripheral to the storage device 318.

Returning to the example of FIG. 4, where the transfer housing 110, 114 is the host, then the processor 314 submits a command to the I/O system 208 to begin a bit for bit copy of the connected peripheral data device at a copy operation 408. Then under the control of the processor 314, the I/O system 312 begins receiving the data from the external device at a receipt operation 410 and then loading that data as a duplicate data device within the storage device 318 at a loading operation 412. The processor 314 then triggers the I/O system 208 to activate the signal 218 once the bit for bit copy is done at a signal operation 414.

Where the transfer housing 110, 114 is the peripheral, then the processor 314 detects whether the host has initiated a retrieval of the data from the host as would occur in the hot zone 106 or a load of the data from the storage device 318 as would occur in the cold zone 102 at determination operation 416. Where the host initiates a retrieval, the processor 314 negotiates the accession of the data stored at particular locations within the host via the I/O system 208 at a negotiation operation 424 and then operational flow proceeds to the receipt operation 410 where the data is obtained.

Where the host initiates a loading of data from the storage device 318, then the processor 314 negotiates a loading of data from the storage device 318 to a storage location within the host at a negotiation operation 418. Then, under control of the processor 314 the I/O system 312 accesses the duplicate device data previously loaded into the storage device 318 and begins loading the data to the negotiated location on the host. The processor 314 then triggers the I/O system 208 to activate the signal 218 once the duplicate device data has been loaded to the host at the signal operation 414.

As discussed above, data may be physically transported from a first location to a second location using embodiments of the container discussed above. Therefore, data may successfully be rescued from contaminated locations and then uploaded to a backup system at an uncontaminated site to preserve the data.

While embodiments have been particularly shown and described, it will be understood by those skilled in the art that various other changes in the form and details may be made therein without departing from the spirit and scope of the invention.

What is claimed is:

1. A container that transfers data from one physical location to another, comprising:
a mobile hermetically sealed storage housing;
a data storage device within the storage housing; and
a contactless data coupler that is within the storage housing, that is in electrical communication with the data storage device, that receives contactless data signals that originate outside of the storage housing, that saves data from the received contactless data signals to the data storage device, that extracts data from the data storage device, and that sends the extracted data via contactless data signals that reach outside of the storage housing.

2. The container of claim 1, further comprising a contactless power coupler that receives contactless power signals that originate outside of the storage housing and that converts the contactless power signals to electrical power.

3. The container of claim 2, further comprising at least one battery within the storage housing that provides electrical power to the data storage device and the contactless data coupler and that receives electrical power from the contactless power coupler.

4. The container of claim 1, further comprising a processing system within the storage housing that provides a data interface between the contactless data coupler and the data storage device.

5. The container of claim 1, further comprising a transfer housing that removably attaches to the storage housing, that includes at least one data connector, that includes a contactless data coupler that is electrically connected to the at least one data connector and that establishes contactless data transfer with the contactless data coupler of the storage housing.

6. The container of claim 5, wherein the at least one data connector comprises at least one of an Ethernet connector, a SCSI connector, an IDE connector, a USB connector, a IEEE 1394 connector, and an optical connector.

7. The container of claim 5, further comprising a battery within the transfer housing that provides power to the contactless data coupler within the transfer housing.

8. The container of claim 1, wherein the contactless data coupler utilizes at least one of a wireless radio frequency signal, an inductive signal, and an optical signal.

9. A container that transfers data from one physical location to another, comprising:
a mobile hermetically sealed transfer housing;
a physical data connector exposed to the exterior of the transfer housing; and
a contactless data coupler that is within the transfer housing, that is in electrical communication with the physical data connector, that receives data signals from the physical data connector, and that sends the received data signals via contactless data signals that reach outside of the transfer housing.

10. The container of claim 9, wherein the at least one data connector comprises at least one of an Ethernet connector, a SCSI connector, an IDE connector, a USB connector, a IEEE 1394 connector, and a fiber connector.

11. The container of claim 9, further comprising a contactless power coupler that receives contactless power signals that originate outside of the transfer housing and that converts the contactless power signals to electrical power.

12. The container of claim 11, further comprising at least one battery within the transfer housing that provides electrical power to the contactless data coupler and that receives electrical power from the contactless power coupler.

13. The container of claim 9, further comprising a hermetically sealed storage housing where the transfer housing removably attaches to the storage housing, where the storage housing includes a storage device and a contactless data coupler that is electrically connected to the storage device and that establishes contactless data transfer with the contactless data coupler of the transfer housing.

14. The container of claim 13, further comprising a battery within the storage housing that provides power to the contactless data coupler and the storage device that are within the storage housing.

15. The container of claim 9, wherein the contactless data coupler utilizes at least one of a wireless radio frequency signal, an inductive signal, and an optical signal.

16. A computer readable medium containing instructions thereon that perform acts comprising:
recognizing via a contactless data coupling located within a hermetically sealed storage housing that a data device exterior to the storage housing is available;
sending commands outside of the storage housing via the contactless data coupling to initiate data retrieval from the data device;
receiving within the storage housing data signals that originate outside of the storage housing via the contactless data coupling where the data signals are representative of data retrieved from the data device; and
loading data from the data signals into a storage device located within the storage housing.

17. The computer readable medium of claim 16, wherein the acts further comprise:
recognizing via the contactless data coupling that a second data device exterior to the storage housing is available;
sending commands outside of the storage housing via the contactless data coupling to initiate data loading to the second data device; and
sending data from the storage device via the contactless data coupling for loading to the second data device.

18. The computer readable medium of claim 16, wherein the acts of recognizing, sending, and receiving comprise communicating with a contactless data coupling of a hermetically sealed transfer housing mated to the storage housing, the transfer housing including a data connector physically connected to a data source.

19. The computer readable medium of claim 18, wherein the data connector comprises at least one of an Ethernet connector, a SCSI connector, an IDE connector, a USB connector, a IEEE 1394 connector, and a fiber connector.

20. The computer readable medium of claim 16, wherein the contactless data coupler utilizes at least one of a wireless radio frequency signal, an inductive signal, and an optical signal.
